(19) United States
(12) Patent Application Publication
(10) Pub. No.: US 2014/0351265 A1
(43) Pub. Date: Nov. 27, 2014

(54) METHOD AND APPARATUS FOR MANAGING WEIGHT OF ITEMS FOR TRANSPORT

(71) Applicant: HERE Global B.V., Veldhoven (NL)

(72) Inventors: Jerome Beaurepaire, Berlin (DE); Philippe Beaurepaire, Tregomar (FR)

(73) Assignee: HERE Global B.V., Veldhoven (NL)

(21) Appl. No.: 13/901,038

(22) Filed: May 23, 2013

(51) Int. Cl. G06F 17/30

(52) U.S. Cl. CPC G06F 17/30867
USPC 707/748

(57) ABSTRACT

An approach is provided for organizing items into receptacle categories based, at least in part, on physical properties of the items. The property platform determines an acquisition of at least one item by at least one user. Next, the property platform causes, at least in part, a querying for at least one physical property value for the at least one item. Then, the property platform determines an organization of the at least one item into one or more receptacle categories based, at least in part, on the physical property value.

### BACKGROUND

Service providers and device manufacturers (e.g., wireless, cellular, etc.) are continually challenged to deliver value and convenience to consumers by, for example, providing compelling network services. One area of interest has been the development of capabilities to group items for transport. For example, consumers may be interested in whether certain items meet packaging requirements. However, consumers must manually compute or keep track of items to adhere to packaging requirements, or face surprise when moving items. As a result, content providers face significant challenges in developing mechanisms to add predictability for consumers transporting items.

### SOME EXAMPLE EMBODIMENTS

Therefore, there is a need for an approach for organizing items into receptacle categories based, at least in part, on physical properties of the items.

According to one embodiment, a method comprises determining an acquisition of at least one item by at least one user. The method also comprises causing, at least in part, a querying for at least one physical property value for the at least one item. The method further comprises determining an organization of the at least one item into one or more receptacle categories based, at least in part, on the physical property value.

According to another embodiment, an apparatus comprises at least one processor, and at least one memory including computer program code, the at least one memory and the computer program code configured to, with the at least one processor, cause, at least in part, the apparatus to determine an acquisition of at least one item by at least one user. The apparatus is also caused to cause, at least in part, a querying for at least one physical property value for the at least one item. The apparatus is further caused to determine an organization of the at least one item into one or more receptacle categories based, at least in part, on the physical property value.

According to another embodiment, a computer-readable storage medium carries one or more sequences of one or more instructions which, when executed by one or more processors, cause, at least in part, an apparatus to determine an acquisition of at least one item by at least one user. The apparatus is also caused to cause, at least in part, a querying for at least one physical property value for the at least one item. The apparatus is further caused to determine an organization of the at least one item into one or more receptacle categories based, at least in part, on the physical property value.

According to another embodiment, an apparatus comprises means for determining an acquisition of at least one item by at least one user. The apparatus also comprises means for causing, at least in part, a querying for at least one physical property value for the at least one item. The apparatus further comprises means for determining an organization of the at least one item into one or more receptacle categories based, at least in part, on the physical property value.

In addition, for various example embodiments of the invention, the following is applicable: a method comprising facilitating a processing of and/or processing (1) data and/or (2) information and/or (3) at least one signal, the (1) data and/or (2) information and/or (3) at least one signal based, at least in part, on (or derived at least in part from) any one or any combination of methods (or processes) disclosed in this application as relevant to any embodiment of the invention.

For various example embodiments of the invention, the following is also applicable: a method comprising facilitating access to at least one interface configured to allow access to at least one service, the at least one service configured to perform any one or any combination of network or service provider methods (or processes) disclosed in this application.

For various example embodiments of the invention, the following is also applicable: a method comprising facilitating creating and/or facilitating modifying (1) at least one device user interface element and/or (2) at least one device user interface functionality, the (1) at least one device user interface element and/or (2) at least one device user interface functionality based, at least in part, on data and/or information resulting from one or any combination of methods or processes disclosed in this application as relevant to any embodiment of the invention, and/or at least one signal resulting from one or any combination of methods (or processes) disclosed in this application as relevant to any embodiment of the invention.

For various example embodiments of the invention, the following is also applicable: a method comprising creating and/or modifying (1) at least one device user interface element and/or (2) at least one device user interface functionality, the (1) at least one device user interface element and/or (2) at least one device user interface functionality based at least in part on data and/or information resulting from one or any combination of methods (or processes) disclosed in this application as relevant to any embodiment of the invention, and/or at least one signal resulting from one or any combination of methods (or processes) disclosed in this application as relevant to any embodiment of the invention.

In various example embodiments, the methods (or processes) can be accomplished on the service provider side or on the mobile device side or in any shared way between service provider and mobile device with actions being performed on both sides.

Still other aspects, features, and advantages of the invention are readily apparent from the following detailed description, simply by illustrating a number of particular embodiments and implementations, including the best mode contemplated for carrying out the invention. The invention is also capable of other and different embodiments, and its several details can be modified in various obvious respects, all without departing from the spirit and scope of the invention. Accordingly, the drawings and description are to be regarded as illustrative in nature, and not as restrictive.

### BRIEF DESCRIPTION OF THE DRAWINGS

The embodiments of the invention are illustrated by way of example, and not by way of limitation, in the figures of the accompanying drawings:

FIG. 1 is a diagram of a system capable of organizing items into receptacle categories based, at least in part, on physical properties of the items, according to one embodiment;

FIG. 2A is a diagram of the components of the property platform, according to one embodiment;

FIG. 2B is a diagram of the components of the limit platform, according to one embodiment;

FIG. 2C is a diagram of the components of the threshold platform, according to one embodiment;

FIG. 2D is a diagram of the components of the organization platform, according to one embodiment;

FIG. 3 is a flowchart of a process for organizing items into receptacle categories based, at least in part, on physical properties of the items, according to one embodiment;

FIG. 4 is a flowchart of a process for determining threshold criteria, according to one embodiment;

FIG. 5 is a flowchart of a process for organizing, determining availability for, and reserving items based, at least in part, on physical properties of the items, according to one embodiment;

FIG. 6 is a flowchart of a process for revising threshold criteria, according to one embodiment;

FIGS. 7A-7B are diagrams of user interfaces utilized in the processes of FIG. 3, according to various embodiments;

FIG. 8 is a diagram of a user interface utilized in the processes of FIG. 3, according to one embodiment;

FIG. 9 is a diagram of a possible procedure utilized in the processes of FIG. 4, according to one embodiment;

FIG. 10 is a diagram of hardware that can be used to implement an embodiment of the invention;

FIG. 11 is a diagram of a chip set that can be used to implement an embodiment of the invention; and

FIG. 12 is a diagram of a mobile terminal (e.g., handset) that can be used to implement an embodiment of the invention.

### DESCRIPTION OF SOME EMBODIMENTS

Examples of a method, apparatus, and computer program for organizing items into receptacle categories based, at least in part, on physical properties of the items are disclosed. In the following description, for the purposes of explanation, numerous specific details are set forth in order to provide a thorough understanding of the embodiments of the invention. It is apparent, however, to one skilled in the art that the embodiments of the invention may be practiced without these specific details or with an equivalent arrangement. In other instances, well-known structures and devices are shown in block diagram form in order to avoid unnecessarily obscuring the embodiments of the invention.

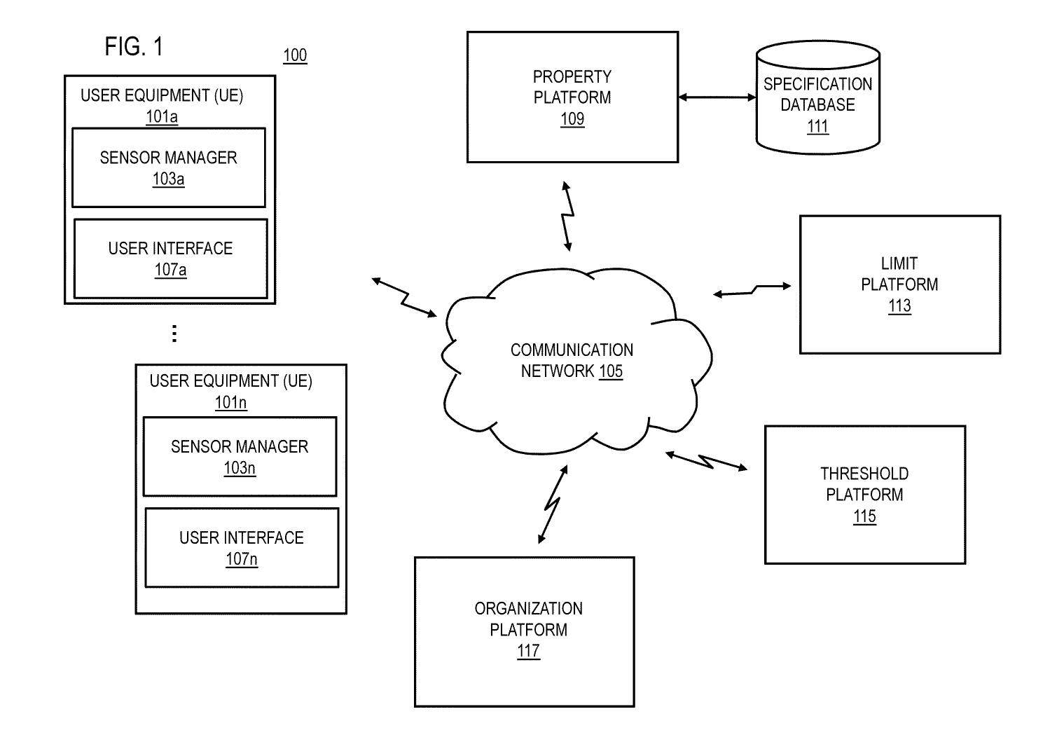

FIG. 1 is a diagram of a system capable of organizing items into receptacle categories based, at least in part, on physical properties of the items, according to one embodiment. Regulations surrounding transporting items are increasingly stringent. For example, airline luggage regulations regarding weight limitations, content limitations, and fluid item limitations often pose a constant impact on travelers. One area of interest has been the development of venues to provide more information to facilitate transport of items. For example, consumers may be interested in whether certain items meet packaging requirements. However, consumers must manually compute or keep track of items to adhere to packaging requirements, or face surprise when traveling. As a result, content providers face significant challenges in streamlining the packaging process for consumers.

To address this problem, a system 100 of FIG. 1 introduces the capability to organize items into receptacle categories based, at least in part, on physical properties of the items. In one embodiment, the system 100 may determine the physical property of a designated item and cause a grouping of the item in a receptacle category. For example, physical properties may include the weight, size, and/or physical composition (solid, liquid, or gas) of the item. Receptacle categories may include various forms of packaging available to a user, for example, various luggage pieces associated with a user, standard sizes of boxes offered by the post office, luggage pieces that a user may definitely or optionally use for a trip, etc.

In one embodiment, the system 100 may group the item in a particular luggage piece, depending on physical property of an item determined by system 100. For example, an airline may allot a 20 kg limit for check-in luggage. The system 100 may determine the physical property of an item, including its weight at 6 kg. The system 100 may then determine that the user may transport the 6 kg item in check-in luggage since 6 kg does not exceed 20 kg. In a further example, the system 100 may determine a cumulative physical measurement. For instance, after grouping the 6 kg item into check-in luggage, the system 100 may determine the physical property of another item to be 10 kg. The system 100 may determine that after the 6 kg luggage, only 14 kg remains for the luggage before the luggage exceeds the 20 kg airline weight regulation. Then, the system 100 may, for instance, group the 10 kg weight into another receptacle category, for example, for shipping directly or change the grouping for the 6 kg weight, and/or cause a display informing a user that the weight limit might be exceeded with the 10 kg item. In a further embodiment, the system may even suggest shipping services for shipping directly. Shipping services may include, service vendors, cost for shipping, timing for shipping, etc. For example, where the system 100 detects extra kg in excess of threshold criteria, the system 100 may generate a notification stating, “We recommend you to ship this product home in 3 days for only 10 Euro vial DHL.” The recommendation may also include a price comparison for various shipping options or navigation means to shipping services. In one instance, the comparison may further include comparing shipping versus paying for limit increases with, for example, airlines.

In another embodiment, the system 100 may offer a recommendation regarding the item depending on a receptacle category grouping. For example, the system 100 may determine one receptacle category as including all the receptacles owned by a particular user and another category as including the receptacles a user plans to use or bring for a particular trip. In one scenario, a user packing for a trip may plan to bring a pair of tall boots. The system 100 may determine that the luggage pieces the user plans to use, do not fit the boots as well as a taller luggage case that the user was originally not anticipating to user. Alternately, receptacle categories may pertain to receptacle characteristics. For example, receptacle characteristics may include hard shelled, soft-shelled, roller, expandable, collapsible, etc. In one scenario, a user may purchase a fragile item such as a vase. Then, the system 100 may determine an organization where the vase is preferably contained in the user's hard-shelled receptacle, rather than a soft, collapsible one.

In one embodiment, the system 100 may determine the items for grouping as acquired items. For example, system 100 may determine a user acquiring an item through purchase. Then, the system 100 may determine a physical property value for the acquired item by accessing a product database. For example, one or more devices within the system 100 may determine a product identification code through the process of paying for the item. With the product identification code, the system 100 may query a database for specifications associated with the item. In one scenario, specifications may include product size, weight, physical state, or a combination thereof. In another embodiment, the system 100 may determine the physical properties of an item via sensors associated with one or more devices. For example, the system 100 may include one or more weight sensors similar to a spring scale, where the one or more sensors may determine a physical property of an item without querying a database. In one scenario, a weight sensor may be detachable from the one or more devices. In another instance, the system 100 may include a sensor that may evaluate the general size or size dimensions of a particular item, for example, a scanner that determines length measurements. The user may then scan length, width, and/or height measurements for the system 100 to determine physical property values regarding dimensions or volume. In certain embodiments the system 100 may determine physical property values of items based on database information, sensor information, or a combination thereof.

In another embodiment, the system 100 may determine an item for grouping, as a selected item. A selected item may include any item that the system 100 has not determined as acquired. For example, a selected item may include items that a user has not yet purchased (but is considering purchasing), an item a user purchased in the past, a gift, etc. A selected item may be an item where the system 100 may not directly determine a product identification code from purchase information.

For example, a user may simply determine an item that may require transport, for instance, a potential souvenir from a trip. Then, the system 100 may determine a product identification code from a general database, then query a product database for the physical properties. For example, the system 100 may determine a product identification code from an online vendor site, a database of items commonly purchased by a particular set of users, or a combination thereof. For instance, tourists to Las Vegas may often buy luxury goods of a particular brand. Then, the system 100 may query the luxury brand database or a consumer database to determine a product identification code and/or product specifications.

As mentioned above, selected items may include items the user already owns but may consider packing. Then, the system 100 may still conduct queries for the item itself through means similar to those described above. In addition, the system 100 may seek to determine similar products. For instance, databases may no longer have product identification codes for user's sweater purchased years ago that he has packed in his suitcase. The system 100 may determine sweaters similar enough to the user's sweater to serve as equivalents in terms of the physical properties. For example, the system 100 may determine the equivalents based on a user's purchasing history, collective user history as determined or kept by a product vendor database, social networking information, product specifications, etc.

After determining physical property values associated with an item, the system 100 may compare the physical property value against threshold criteria. For example, the 20 kg limit set by airline regulations may serve as a weight limit. Comparing a 6 kg item again the 20 kg limit may allow the system 100 to determine whether the 6 kg may fit into an item of luggage without exceeding the regulation limit. In one embodiment, the system 100 add a physical property value to a cumulative physical property value associated with a user, then compare the sum of the two values against a limit. In doing so, the system 100 may incrementally monitor the physical properties of items to be stored within a receptacle, against limitations associated with the receptacle. In one embodiment, the comparison may further include an initial value associated with the receptacle. For example, a receptacle may weigh 1 kg when it is empty. Then, the system 100 may add a 6 kg acquired item to the initial 1 kg weight to determine that the user has only 13 kg left of possible weight to add to his luggage, if he is to not exceed the 20 kg limit. The 13 kg may then serve as threshold criteria that inform subsequent items.

For example, a user may already exceed his threshold criteria, but still have other items he would like to purchase and transport. Then, the user may make a selection of the items with system 100. System 100 may then determine the availability of the items and show the availability of the items at one or more locations. For example, the system 100 may indicate to a user that a product is available in airport duty free shops. Thus, rather than buying an item that may create trouble for the user in checking in his luggage or meeting fluid limits for carry-on luggage, system 100 may inform the user of opportunities to acquire the item in the airport after the user is past airport check-in and security. In this case, the system 100 may take into account a user's specific itinerary and display availability relative to a user's travel plans. For example, the system 100 may only display product availability at airports where a user will be and/or where a layover permits time to make the purchase. Availability may include indicating that a product is ready for purchase, locations and contact information with item availability, the number of the items in stock, routes to the locations, pricing information or price comparisons, or a combination thereof.

In another example, the system 100 may display the availability of an item, independent of a user. For example, where an item is a perishable good, a user may not want to purchase the good too early. Then, system 100 may offer information regarding the availability of the good for the user to purchase close to the user's departure date, independent of user's travel route. In one embodiment, the system 100 may further reserve the selected item at the one or more locations. Furthermore, the system 100 may initiate ordering the selected item at the locations if the locations typically carry the item, but appear low on stock or have the risk of selling out before the user may acquire the item. The system 100 may employ these various methods to ensure that users may acquire selected items.

In one embodiment, the system 100 may further determine operations associated with service providers and cause changes to threshold criteria based, at least in part, on the operations. For example, the operations may include customer categorizations, sales promotions, policy changes, user groupings, receptacle classifications, or a combination thereof. Customer categorizations may include business class customers, customers with a certain number of frequent fliers, special customers (including celebrities or those with special needs), or a combination thereof. Sales promotions may include airline promotions or user purchases. For example, airlines sometimes charge a fine where users' checked luggage exceeds a certain weight limit. As a special airline sales promotion, an airline may offer users special deals on flights, where users may have luggage that exceeds the weight limit without being fined. Alternately, sales promotions may include an airline giving users the option to “purchase” the privilege of having a higher luggage weight limit. For example, where a standard luggage weight limit is 20 kg, an airline may offer users the option to pay $50 to increase their luggage weight limit to 25 kg. Policy changes may include where countries, airlines, or federations change their policies and regulations pertaining to physical property limits allowable for travel and/or shipment.

User groupings may include families, travel companions, travel groups, and/or user characteristics, for instance. For example, users that are part of families travelling together may group together such that their limit is a collective limit. As previously discussed, the system 100 may recognize a family of three travelling together as having 60 kg as their luggage weight limit where a limit for one user may be 20 kg. In one embodiment, the system 100 may optimize the organization of items into the receptacle categories based on the ascertained physical property value. For example, one user's luggage piece may be almost full while the system 100 determines that the user's sister has plenty of room in her luggage. Then, the system 100 may organize the user's newly acquired snow globe to be organized into the sister's luggage since the snow globe will not fit in the user's luggage. For another example, user characteristics may include users of certain ages or physical limitations. For example, the system 100 may determine that a user is 9 years old. Then, despite airlines potentially not setting weight limitations on carry-on luggage, system 100 may determine that, categorically, 9 year old children carrying weights exceeding 15 kg sustain muscle injuries. Then, the system 100 may set a limit or threshold criteria based on the user characteristic. Similarly, limit or threshold criteria may be adjusted for certain injuries. For example, the system 100 may alter a limit or threshold criteria according to the abilities of a user with a knee replacement or back problems. In a further embodiment, the system 100 may share the information within a social network or among certain groups of users. For example, the organization may be shared within a family traveling together so that family members can simultaneously track their collective cumulative physical property values.

Receptacle classifications may include, for example, check-in versus carry-on luggage. For example, if a user purchases a fluid substance that exceeds the limits regarding fluids in carry-on luggage, the system 100 may organize the substance to the check-in luggage classification, suggesting that the user store the purchase in his check-in luggage rather than the carry-on. For another example, the system 100 may alert a user of exceeding threshold criteria prior to the user acquiring an item. For example, the system 100 may determine that the user selected an item that would cause the user's receptacle to exceed its volume limit. In one scenario, a user with only a carry-on bag may select a bottle of perfume that would exceed the limit for fluids permitting for carry-on bags. The system 100 may then alert or notify the user of this issue, prior to a user acquiring the perfume. The system 100 may also recommend that the user ship the perfume or acquire a check-in luggage case, especially where the user selects a substantial number of items to acquire. Yet another example of system 100's optimization capabilities may include determining that a user's recent purchase exceeds the limit, but determining that re-organization of another item may resolve the issue. For example, a volume limit for fluids in check-in luggage might be 3 ounces of fluids. A user may have a cumulative volume value of 2 ounces from 0.5 ounces of one fluid and 1.5 ounces of another fluid. The user may then acquire a third item consisting of 1.5 ounces of fluid. The system 100 may determine that the user may carry the two 1.5-ounce fluids together in the carry-on luggage to optimize the user's packing considerations relative to the limit.

As shown in FIG. 1, the system 100 comprises a user equipment (UE) 101a-101n (or UEs 101) having connectivity to sensor managers 103a-103n (or sensor managers 103), user interfaces 107a-107n (or user interfaces 107), a property platform 109, a specification database 111, a limit platform 113, a threshold platform 115, and an organization platform 117 via a communication network 105. By way of example, the communication network 105 of system 100 includes one or more networks such as a data network (not shown), a wireless network (not shown), a telephony network (not shown), or any combination thereof. It is contemplated that the data network may be any local area network (LAN), metropolitan area network (MAN), wide area network (WAN), a public data network (e.g., the Internet), short range wireless network, or any other suitable packet-switched network, such as a commercially owned, proprietary packet-switched network, e.g., a proprietary cable or fiber-optic network, and the like, or any combination thereof. In addition, the wireless network may be, for example, a cellular network and may employ various technologies including enhanced data rates for global evolution (EDGE), general packet radio service (GPRS), global system for mobile communications (GSM), Internet protocol multimedia subsystem (IMS), universal mobile telecommunications system (UMTS), etc., as well as any other suitable wireless medium, e.g., worldwide interoperability for microwave access (WiMAX), Long Term Evolution (LTE) networks, code division multiple access (CDMA), wideband code division multiple access (WCDMA), wireless fidelity (WiFi), wireless LAN (WLAN), Bluetooth®, Internet Protocol (IP) data casting, satellite, mobile ad-hoc network (MANET), and the like, or any combination thereof.

The UE 101 is any type of mobile terminal, fixed terminal, or portable terminal including a mobile handset, station, unit, device, multimedia computer, multimedia tablet, Internet node, communicator, desktop computer, laptop computer, notebook computer, netbook computer, tablet computer, personal communication system (PCS) device, personal navigation device, personal digital assistants (PDAs), audio/video player, digital camera/camcorder, positioning device, television receiver, radio broadcast receiver, electronic book device, game device, or any combination thereof, including the accessories and peripherals of these devices, or any combination thereof. It is also contemplated that the UE 101 can support any type of interface to the user (such as “wearable” circuitry, etc.).

In one embodiment, the sensor managers 103 may determine physical property values associated with items based on sensor input. For example, the sensor managers 103 may determine sensors available to inherent in the UEs 101 and/or sensor attachments to UEs 101. Then, the sensor managers 103 may determine sensor data input and find product identification codes and/or product specification information based, at least in part, on the sensor input. As previously discussed, examples of such sensory input may include spatial or length measurements to determine size, weight measurements, or a combination thereof. In one embodiment, the sensor managers 103 may also detect other UEs 101 and prompt sharing of physical property values, cumulative physical property values, threshold criteria, or a combination thereof. In one instance, users sharing receptacle spaces may then determine items for transport or threshold criteria relative to their shared receptacle spaces.

In one embodiment, the user interfaces 107 may determine physical property values based on acquisition information, selection information, or a combination thereof. For example, the user interfaces 107 may provide an interface through which a user acquires an item. For example, a user may purchase an item through his mobile device, UE 101a such that the user interface 107a of UE 101a may then determine the product identification code of the item and subsequently find the item properties. In another example, the user interface 107 may permit a scanning of a bar code and/or quick response code (QR code) associated with one or more items. For instance, a user may buy an item and check out at the store as he usually would, then scan the product bar code with his mobile device. In yet another example, a user may take a picture of the product via a user interface 107a, whereupon the respective UE 101a may determine an item and/or product identification code using, at least in part, image recognition functionality of the UE 101a.

In another embodiment, the user interfaces 107 may present display that includes items, their respective physical property values, values of limits, cumulative physical property values, threshold criteria, or a combination thereof. For example, the display may include a list of items and their weights with a running total of the weights of items grouped in a particular receptacle category. In some scenarios, various such lists may be associated with different users, groups of users, receptacle categories, threshold criteria, altered threshold criteria, etc. In another embodiment, the user interfaces 107 may present a warning or notification where an item exceeds threshold criteria. In yet another embodiment, the user interfaces 107 may include a prompt for the user to query for physical property values after determining a selection and/or acquisition. For example, the user interfaces 107 may direct a user on how to scan bar codes or gather data regarding item and/or receptacle dimensions.

In one embodiment, the property platform 109 may determine physical property values associated with items. For example, the property platform 109 may determine acquisition or selection of items based on input from the user interfaces 107, then query databases for product specifications. For example, the property platform 109 may receive, from the user interfaces 107, data sufficient to determine product identification codes, and then find databases where that may contain further information on the product. In one embodiment, the property platform 109 may be tasked with finding appropriate databases in which to find physical property values associated with products. For example, different databases may contain information relating to different products. The property platform 109 may determine the databases to contact. In another embodiment, the property platform 109 may determine a confirmation

In one embodiment, the specification database 111 may hold and collect product specifications, including physical property values associated with various items. For example, the specification database 111 may be organized such that the specification database 111 may access product specifications simply by receiving a product identification code. In another example, the specification database 111 may include item cross-referencing information or capability to offer information on product equivalents or similar items. In yet another embodiment, the specification database 111 may continually update, monitor, and/or add new information regarding the items. For example, vendors may change the packaging of certain items, discontinue some items, and/or offer limited edition versions of some items. The specification database 111 may continually keep track of these changes in available items and retire outdated information.

In one embodiment, the limit platform 113 may determine the limits for one or more receptacles and/or receptacle categories. For example, the limit platform 113 may determine regulations associated with government policies, locations, airlines, flight types, users, or a combination thereof. Such limits may include weight limits, size limits, volume limits, or a combination thereof. For example, the limit platform 113 may determine a user's purpose or itinerary and infer one or more limits associated with a user's itinerary. For example, the limit platform 113 may determine that a user is flying an internationally. Then, the weight limit may be 20 kg for a check-in luggage receptacle and volume limits may vary depending on where the user is departing from. In another embodiment, the limit platform 113 may account for particular user characteristics. For example, regulations may not specify a weight limitation for carry-on luggage, but a user may have particular back or knee problems where a doctor has recommended that the user not carry weights exceeding 10 kg. Then, the limit platform 113 may also include limits associated particular to users. In another embodiment, the limit platform 113 may determine operations that may alter limits. For example, a user may qualify for an airline promotion allowing him to bring weights in excess of the usual limits. The limit platform 113 may then determine that the operation of taking advantage of the airline promotion changes the usual regulation limit.

In one embodiment, the threshold platform 115 may determine the threshold criteria. For example, the threshold platform 115 may receive limits from the limit platform 113, physical property values from the property platform 109, and then determine threshold criteria as the difference between the received values and the limit. In one embodiment, the threshold platform 115 may further account for initial values associated with receptacles and, by extension, receptacle categories. In one embodiment, the threshold platform 115 may further determine whether or when a threshold limit is exceeded. For example, the threshold platform 115 may interact with the user interfaces 107 to generate a warning of exceeding a limit or nearing a certain range close to threshold criteria.

In one embodiment, the organization platform 117 may determine an organization of items into receptacle categories based, at least in part, on physical property values associated with the items. In one embodiment, the organization platform 117 determines the organization especially those physical property values with respect to threshold criteria and/or limits associated with receptacles. In one embodiment, the organization platform 117 may further make recommendations based, at least in part, on the organization. For example, the organization platform 117 may determine organize items in ways to optimize packing such that the organization platform 117 may recommend that a user bring one luggage piece over another luggage piece. For example, certain items may spatially fit better given the shape of one particular piece of luggage over another piece of luggage, even though both pieces of luggage have the same volume. Receptacle categories for such a case may include, “possible luggage pieces to bring or use” versus “luggage pieces that a user is certain to use.” In another example, receptacle categories may include “ship” or “pack.” The organization platform 117 may organize some items into the “ship” category and work with the user interfaces 107 to recommend that a user ship or reserve an item, rather than acquire it, based on the determined organization.

By way of example, the UE 101, sensor managers 103a-103n (or sensor managers 103), user interfaces 107a-107n (or user interfaces 107), a property platform 109, a specification database 111, a limit platform 113, a threshold platform 115, and an organization platform 117 communicate with each other and other components of the communication network 105 using well known, new or still developing protocols. In this context, a protocol includes a set of rules defining how the network nodes within the communication network 105 interact with each other based on information sent over the communication links. The protocols are effective at different layers of operation within each node, from generating and receiving physical signals of various types, to selecting a link for transferring those signals, to the format of information indicated by those signals, to identifying which software application executing on a computer system sends or receives the information. The conceptually different layers of protocols for exchanging information over a network are described in the Open Systems Interconnection (OSI) Reference Model.

Communications between the network nodes are typically effected by exchanging discrete packets of data. Each packet typically comprises (1) header information associated with a particular protocol, and (2) payload information that follows the header information and contains information that may be processed independently of that particular protocol. In some protocols, the packet includes (3) trailer information following the payload and indicating the end of the payload information. The header includes information such as the source of the packet, its destination, the length of the payload, and other properties used by the protocol. Often, the data in the payload for the particular protocol includes a header and payload for a different protocol associated with a different, higher layer of the OSI Reference Model. The header for a particular protocol typically indicates a type for the next protocol contained in its payload. The higher layer protocol is said to be encapsulated in the lower layer protocol. The headers included in a packet traversing multiple heterogeneous networks, such as the Internet, typically include a physical (layer 1) header, a data-link (layer 2) header, an internetwork (layer 3) header and a transport (layer 4) header, and various application (layer 5, layer 6 and layer 7) headers as defined by the OSI Reference Model.

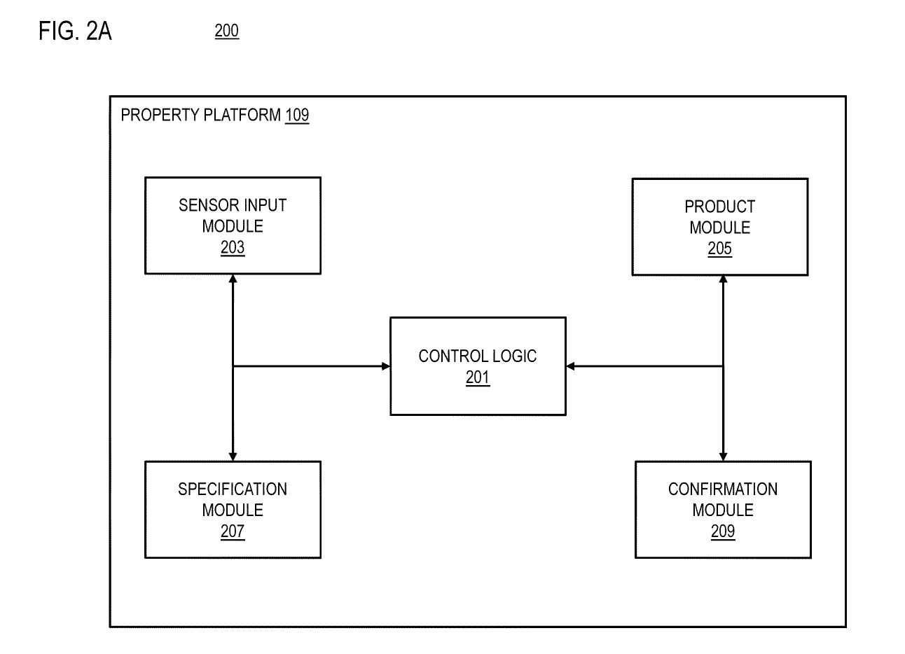

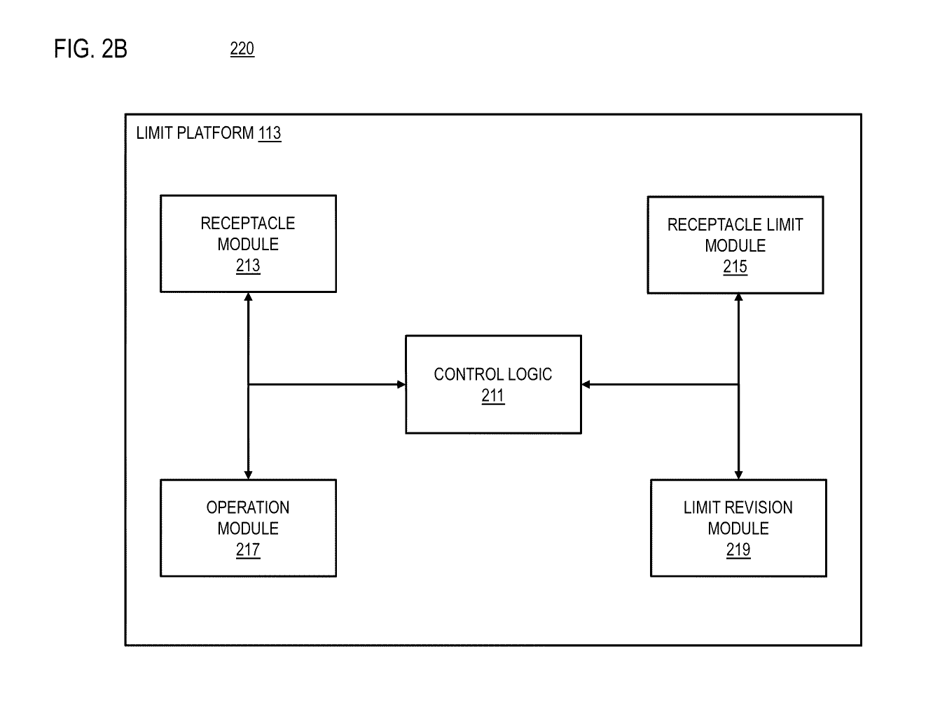

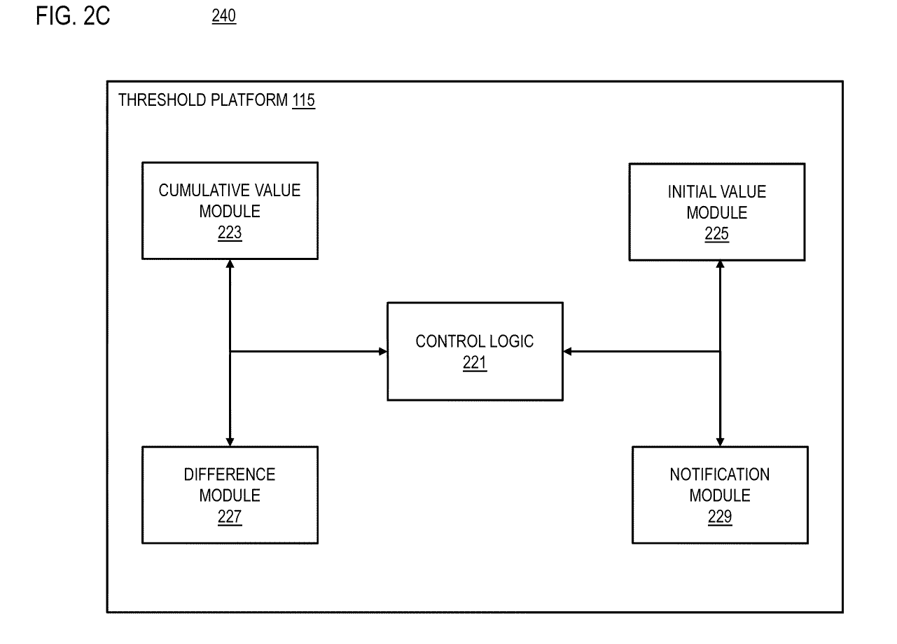

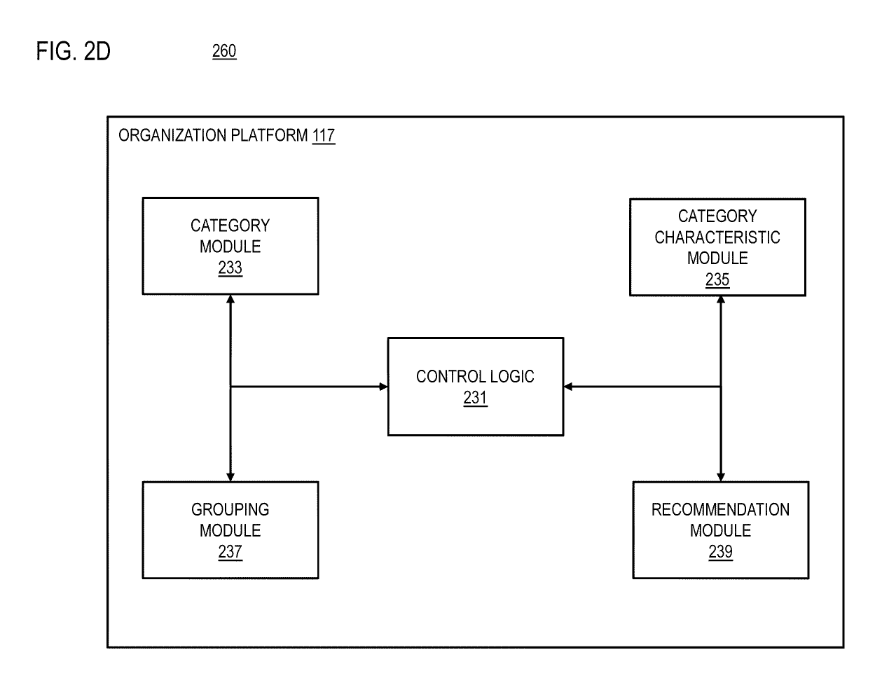

FIG. 2A is a diagram of the components of the property platform 109, according to one embodiment. By way of example, the property platform 109 includes one or more components for determining physical property values associated with items. It is contemplated that the functions of these components may be combined in one or more components or performed by other components of equivalent functionality. In this embodiment, the property platform 109 includes control logic 201, sensor input module 203, product module 205, specification module 207, and confirmation module 209.

In one embodiment, the control logic 201 and sensor input module 203 receive input regarding an acquired or selected item. For example, the control logic 201 and sensor input module 203 may determine a picture taken of a bar code or item, scanned dimensions including length, width, or height, or a combination thereof. In another example, the control logic 201 and sensor input module 203 may also take measurements, including weight measurements. In one embodiment, the control logic 201 and sensor input module 203 may determine acquisition of an item, for example, by determining the purchase of an item. For example, the picture taken of the bar code may both serve as input for purchasing the item, and for the system 100's organization. In one embodiment, the input may also include input regarding receptacle categories, receptacles, or a user's travel plans. For example, a user may also scan his flight confirmation code for the system 100 to extract the nature of the flight and weight, volume, or size limitations associated with that type of flight or locations associated with the flight. For example, the control logic 201 and sensor input module 203 may receive a confirmation code scan revealing that a user is traveling internationally. The control logic 201 may then user this information to help determine limits associated with international travel.

In one embodiment, the control logic 201 and the product module 205 may then determine a means of item identification. For example, the control logic 201 and the product module 205 may determine, from a scanned bar code, a product identification code for an item. In one embodiment, the control logic 201 and the product module 205 may identify a product via image recognition from an image taken of the product or a code associated with the product. Then, the control logic 201 and product module 205 may interact with a specification database 111. By similar means, the control logic 201 and the product module 205 may determine receptacles associated with users, for example, to determine initial values. For example, the control logic 201 may determine an image of a piece of luggage and identify that luggage item. Then, the control logic 201 may determine the initial weight of the luggage item.

In one embodiment, the control logic 201 and specification module 207 may receive, from the specification database 111, specifications associated with an identified item. For example, the specifications may include, at least in part, physical property values for the item. In one embodiment, the control logic 201 and specification module 207 may also determine equivalent products based, at least in part, on the physical property values retrieved from the specification database 111.

In one embodiment, the control logic 201 and the confirmation module 209 may work with user interfaces 107 to prompt a confirmation that the specifications are accurate for an item. For example, the control logic 201 and confirmation module 209 may first initiate a display requesting confirmation that that the item identified by the control logic 201 is, indeed, the acquired or selected item. If correct, the control logic 201 and confirmation module 209 may go on to request verification that the determined physical property values appear correct. In one embodiment, the control logic 201 and confirmation module 209 may receive the verification from a user. In another embodiment, the control logic 201 and confirmation module 209 may seek verification from user history, related users, similar users, social networking information, etc.

FIG. 2B is a diagram of the components of the limit platform 113, according to one embodiment. By way of example, the limit platform 113 includes one or more components for determining the limits for one or more receptacles and/or receptacle categories. It is contemplated that the functions of these components may be combined in one or more components or performed by other components of equivalent functionality. In this embodiment, the limit platform 113 includes a control logic 211, receptacle module 213, receptacle limit module 215, operation module 217, and limit revision module 219.

In one embodiment, the control logic 211 and receptacle module 213 may determine a receptacle and/or receptacle category. For example, the control logic 211 may determine one receptacle associated with a user, for instance, a user's duffel bag. For example, a user may manually enter this information through a user interface, or a user may take a picture of his duffel bag and designate it as belonging or being associated with her. In another instance, the control logic 211 may determine a receptacle category, for example, “carry-on luggage.”

In one embodiment, the control logic 211 and the receptacle limit module 215 may then determine limits based, at least in part, on the information determined by the control logic 211 and receptacle module 213. For example, with carry-on luggage, the control logic 211 and receptacle limit module 215 may determine size limits in terms of the dimensions of the receptacle, as well as fluid volume limits. For a receptacle categorized as “check-in”, the control logic 211 and the receptacle limit module 215 may determine weight limits.

In one embodiment, the control logic 211 and operation module 217 may determine various operations with the potential to alter the limits. First, the control logic 211 and operation module 217 may determine various such operations, including sales promotions, policy changes, user groupings, etc. Then, the control logic 211 and operation module 217 may determine that an operation applies to a user in question. For example, the control logic 211 and operation module 217 may determine a user buying an airline promotion allowing him one extra piece of luggage or the ability to carry 5 kg above the usual weight limits.

In one embodiment, the control logic 211 and the limit revision module 219 may change the limit determined by the receptacle limit module 215, based, at least in part, on information from the control logic 211 and operation module 217. For example, where a user buys the privilege to have one additional piece of luggage, the control logic 211 and limit revision module 219 may change his limit from 20 kg, to 40 kg. As another example, where a user buys the option to carry 5 kg more, the control logic 211 may change that user's limit from 20 kg, to 25 kg.

FIG. 2C is a diagram of the components of the threshold platform 115, according to one embodiment. By way of example, the threshold platform 115 includes one or more components for determining threshold criteria. It is contemplated that the functions of these components may be combined in one or more components or performed by other components of equivalent functionality. In this embodiment, the threshold platform 115 includes a control logic 221, cumulative value module 223, initial value module 225, difference module 227, and notification module 229.

In one embodiment, the control logic 221 and cumulative value module 223 may determine the sum of all the items already organized such that it is associated with a receptacle. For example, a user may acquire a new souvenir, but have acquired other five souvenirs since starting her trip. Then, the control logic 211 and cumulative value module 223 may determine the sum of physical property values associated with the first five souvenirs. In a further embodiment, the control logic 211 and cumulative value module 223 may also add a physical property value of the most recent souvenir to that of the previous five to render a cumulative property value.

In one embodiment, the control logic 221 and the initial value module 225 may determine the initial values associated with receptacles. For example, from the property platform 109, the control logic 221 may receive identifications of a particular receptacle, along with its specifications. From the specifications, the control logic 221 and the initial value module 225 may extract the initial values relevant for determining a threshold value. For example, if weight is in question, the control logic 221 and initial value module 225 may determine the weight of a receptacle when it is empty, based on the specifications from the property platform 109.

In one embodiment, the control logic 221 and the difference module 227 may then take the difference between the limits and the cumulative physical property values and/or initial values to determine threshold criteria. For example, where a limit is 20 kg and a cumulative physical property value is 12 kg, the control logic 221 and difference module 227 may determine threshold criteria to be 8 kg. Where initial values are taken into account, the control logic 221 and the difference module 227 may determine, for the previous example, that a receptacle for the items making up the 12 kg cumulative physical property value, is 1 kg. Then, the control logic 221 and difference module 227 may find the threshold criteria to be 7 kg (20 kg−12 kg−1 kg=7 kg). Also, the cumulative physical property value may be zero where items are not yet acquired or selected. Again using the previous example, the control logic 221 and the difference module 227 may find the threshold criteria to be 19 kg, as the difference between a 20 kg limit and the 1 kg initial value of the receptacle.

In one embodiment, the control logic 221 and the notification module 229 may create a notification or warning where a user exceeds a threshold criteria. For example, if an acquisition would go over a 20 kg limit, the control logic 221 and notification module 229 may work with user interfaces 107 to generate a notification warning the user of the excess. In another embodiment, the control logic 221 and notification module 229 may warn a user when the user is within a certain range of a limit. For example, the control logic 211 and notification module 229 may create a warning where weight threshold criteria is less than 1 kg, meaning the user has only 1 kg left before he exceeds a weight limit. In one embodiment, the control logic 221 and notification module 229 may create notifications based on user preference.

FIG. 2D is a diagram of the components of the organization platform 117, according to one embodiment. By way of example, the organization platform 117 includes one or more components for determining an organization of items into receptacle categories based, at least in part, on physical property values associated with the items. It is contemplated that the functions of these components may be combined in one or more components or performed by other components of equivalent functionality. In this embodiment, the property platform 109 includes control logic 231, category module 233, category characteristic module 235, grouping module 237, and recommendation module 239.

In one embodiment, control logic 231 and category module 233 determine receptacle categories, for example, types of receptacles or relation of receptacles to users. As previously discussed, types of receptacles may include receptacles that are rolling, small, large, hard shell, collapsible, etc. Categorizing receptacles based on their relations to users may include whether users are contemplating using particular receptacles. In one embodiment, control logic 231 and category module 233 may further include category groupings or sub-categories. For example, user A may not have any collapsible receptacles, but he may have access to a collapsible receptacle owned by his wife. The control logic 231 and category module 233 may determine that the collapsible receptacle owned by his wife is associated with user A. An example of sub-categories may include receptacles categorized by which family member the receptacle of a certain type, belongs to.

In one embodiment, control logic 231 and category characteristic module 235 may determine characteristics associated with each of the receptacle categories. For example, characteristics may include “often used”, “new”, “belonging to my sister”, etc. Characteristics may also include receptacle descriptors including: waterproof, hard shell, soft shell, collapsible, expandable, etc.

In one embodiment, the control logic 231 and grouping module 237 may determine an organization of items into the receptacle categories based, at least in part, on physical property values. Taking into account physical property values and receptacle categories, the control logic 231 and grouping module 237 may group items into one receptacle category or another. In one embodiment, the control logic 231 and grouping module 237 may find an item as simultaneously fitting into more than one receptacle category. In another embodiment, the control logic 231 and grouping module 237 may optimize an organization. For example, the control logic 231 and grouping module 237 may determine that a particular item is a better spatial fit for one particular receptacle that a user was not initially prepared to bring, over the receptacles that a user planned to use for a trip.

In one embodiment, the control logic 231 and recommendation module 239 may work with user interfaces 107 to present, to users, the organizations. In one embodiment, the organizations serve as recommendations or suggestions for packing or shipping. For example, where an item is a better spatial for a particular receptacle, the control logic 231 and recommendation module 239 may suggest to a user, that the user use the particular receptacle rather than the one she initially planned to use. In another embodiment, the control logic 231 and recommendation module 239 may present various alternatives for a user. For example, the control logic 231 and recommendation module 239 may recommend that a user move an item to his carry-on bag (in a carry-on bag category) so that he does not exceed limits on liquid volumes in carry-on luggage. The control logic 231 and recommendation module 239 may also recommend the user ship the item, purchase the item in the airport, or offer a different packing configuration, all as alternatives.

In a further embodiment, the control logic 231 and recommendation module 239 may offer details regarding shipping or purchasing the item. For example, the control logic 231 and recommendation module 239 may assess and present various shipping vendors in the vicinity of users, respective prices the vendors charge for shipping the item, and navigation information for the shipping vendors with respect to users' locations. If a user selects an item, the control logic 231 and recommendation module 239 may recommend similar items that may better allow a user to stay under threshold criteria. For example, the control logic 231 and recommendation module 239 may determine the availability of paperback books or e-books in place of a leather bound book and recommend the replacement to a user. Another example may include recommending smaller packages of a similar product. For example, a user may contemplate purchasing a bottle of perfume that would exceed the limit allowed for fluids in carry-on bags. The control logic 231 and recommendation module 239 may determine that a store two blocks away carries the same perfume in a smaller packaging, and make the suggestion to a user. Another example may include a user considering a gift package of perfumes that is packaged in an unwieldy, large box. The control logic 231 and recommendation module 239 may recommend a package that has identical or almost identical contents, but is packaged in a way that better suits a user's volume limits. In one embodiment, the control logic 231 and recommendation module 239 may pair its recommendations with sales promotions. For example, the control logic 231 and recommendation module 239 may recommend the comparable, more compact gift package along with a coupon for a discounted price.

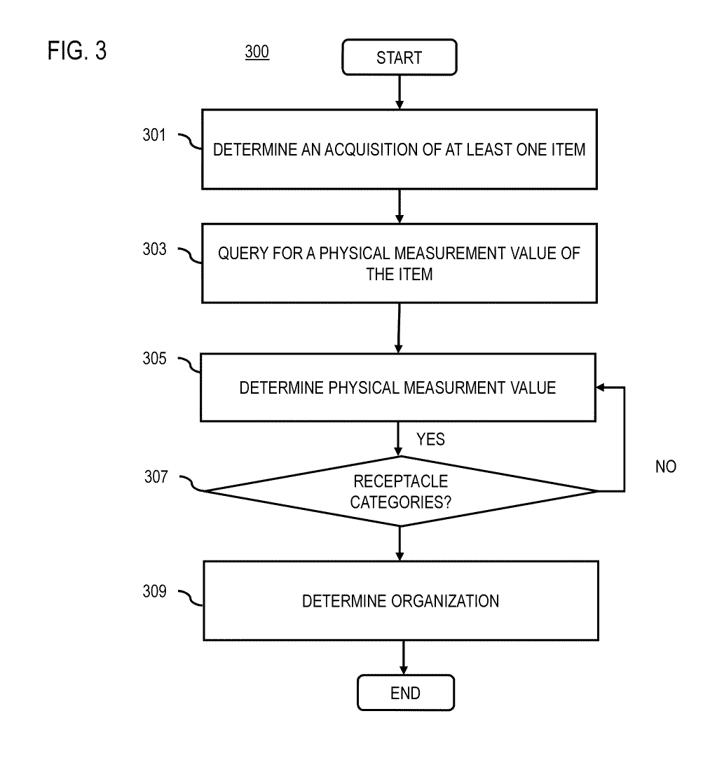

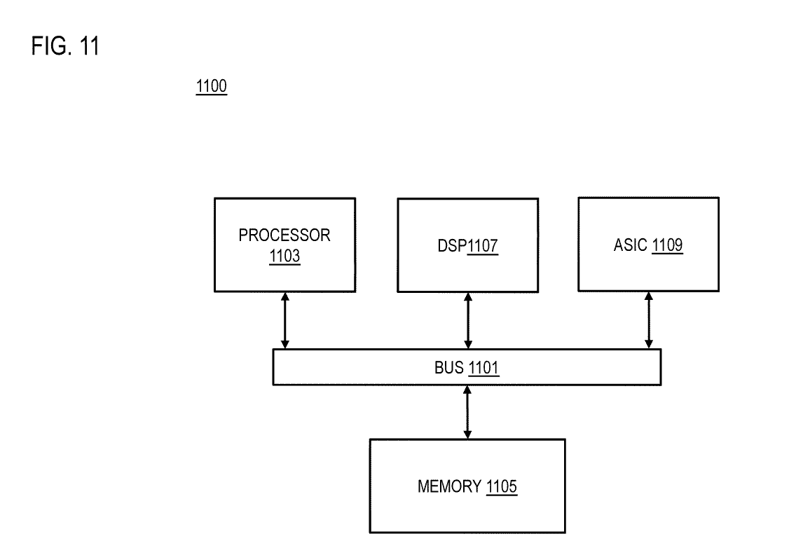

FIG. 3 is a flowchart of a process for organizing items into receptacle categories based, at least in part, on physical properties of the items, according to one embodiment. In one embodiment, the organization platform 117 performs the process 300 and is implemented in, for instance, a chip set including a processor and a memory as shown in FIG. 11. In step 301, the control logic 231 may determine an acquisition of at least one item by at least one user. For example, the control logic 231 may determine an acquisition where the UE 101 directly participates in the acquisition. For instance, the control logic 231 may determine the acquisition while the UE 101 serves as the means by which a user purchases an item, for example, when a user purchases an item online via his mobile device. In another embodiment, the control logic 231 may also determine an acquisition when a UE 101 does not directly participate in the acquisition. For example, the control logic 231 may determine acquisition of an item when a user scans his receipt or scans the bar code of an acquired item. In a further example, the control logic 231 may also be associated with a user's credit card activity so that the control logic 231 is aware of purchase information.

For steps 303 and 305, the control logic 231 may cause, at least in part, a querying for at least one physical property value for the at least one item. For example, the control logic 231 may contact a database for specification information including physical property values associated with a given item. In another embodiment, the control logic 231 may receive sensory input or prompt sensory data intake to determine physical property values. In one embodiment, the physical property values are wherein the at least one physical property value includes, at least in part, a weight value, a physical dimension value, a physical state, or a combination thereof. For steps 307 and 309, the control logic 231 may then determine an organization of the at least one item into one or more receptacle categories based, at least in part, on the physical property value. For example, the control logic 231 may determine that an item exceeds regulation limits, is perishable, or has dimensions not conducive for packing in luggage without damaging the item itself or other items. Then, for step 309, the control logic 231 may organize the item into a receptacle category for shipping, rather than transporting as part of a user's luggage.

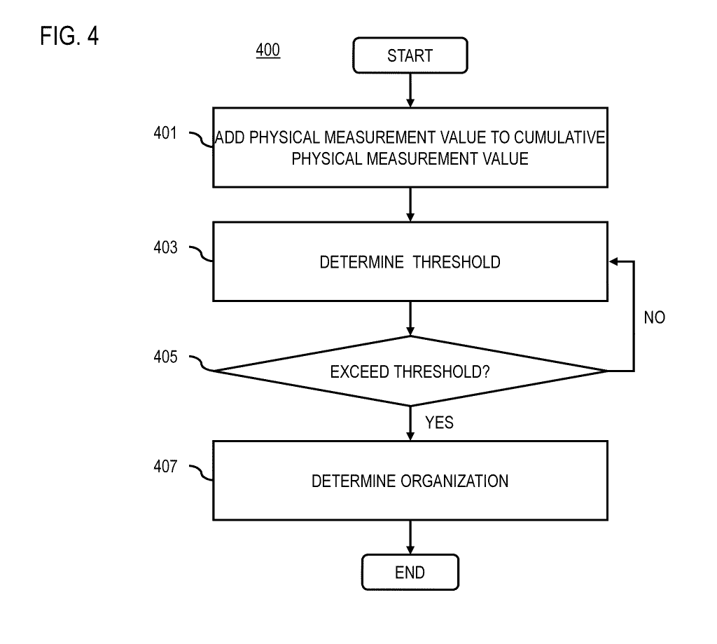

FIG. 4 is a flowchart of a process for determining threshold criteria, according to one embodiment. In one embodiment, the threshold platform 115 performs the process 400 and is implemented in, for instance, a chip set including a processor and a memory as shown in FIG. 11. In step 401, the control logic 221 may cause, at least in part, an addition of the at least one physical property value to at least one cumulative physical property value associated with the at least one user. For example, a user may have already acquired 6 kg worth of items. This 6 kg may be the cumulative physical property value. Should the user then acquire another item that is 4 kg, the control logic 221 may add the 4 kg physical property value of the newest item, to the 6 kg cumulative physical property value. For steps 403 and 405, the control logic 221 may cause, at least in part, a comparison of the at least one cumulative physical property value, an initial weight value, or a combination thereof, against one or more threshold criteria. In one embodiment, the control logic 221 may make the comparison wherein the one or more threshold criteria is based, at least in part, on at least one weight limit, at least one size limit, at least one volume limit, or a combination thereof of a receptacle. Furthermore, the control logic 221 may determine the one or more threshold criteria based, at least in part, on a difference between (a) the at least one weight limit, the at least one size limit, the at least one volume limit, or a combination thereof, and (b) the weight value, the initial weight value, an initial size value, an initial volume value, or a combination thereof for the receptacle. For step 407, the control logic 221 may then contribute to the organization of the item into one or more receptacle categories based on the determined threshold criteria.

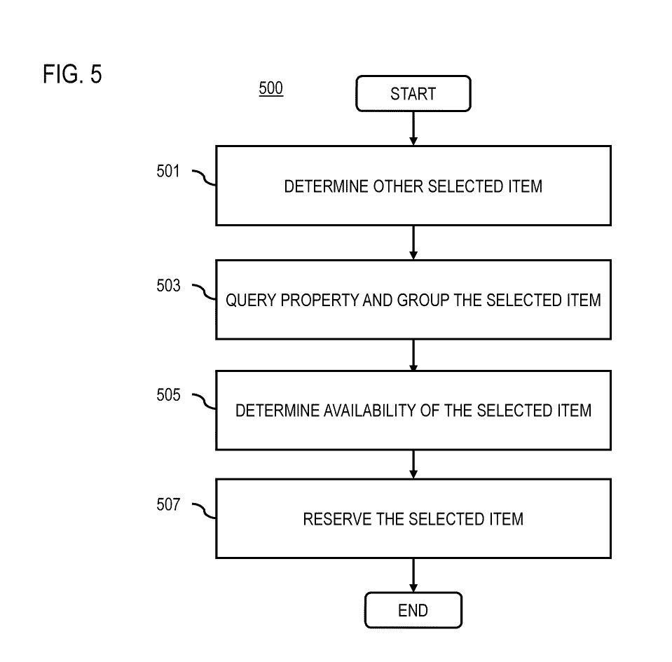

FIG. 5 is a flowchart of a process for organizing, determining availability for, and reserving items based, at least in part, on physical properties of the items, according to one embodiment. In one embodiment, the organization platform 117 performs the process 500 and is implemented in, for instance, a chip set including a processor and a memory as shown in FIG. 11. In step 501, the control logic 231 may determine a selection of at least one other item. For example, the control logic 231 may determine that a user has moved an item into a “shopping cart” or somehow denoted a desire to potentially acquire and transport the item. Then for step 503, the control logic 231 may cause, at least in part, a querying for at least one physical property of the at least one selected item and cause, at least in part, a grouping of the at least one selected item distinct from the at least one acquired item. For example, the control logic 231 may separate selected items from acquired items and prompt further operations for the selected items.

For instance, the control logic 231 may then determine availability of the at least one selected item at one or more locations and cause, at least in part, a display showing the availability of the at least one selected item at the one or more locations. For example, the control logic 231 may determine that a selected item is available for purchase at shops within airports along a user's travel route and recommend that the user purchase the item at the airport to avoid issues with security checks. Furthermore, the control logic 231 may determine a request to reserve the at least one selected item at the one or more locations. For example, the control logic 231 may contact item vendors to hold the item for a user to purchase at the one or more locations.

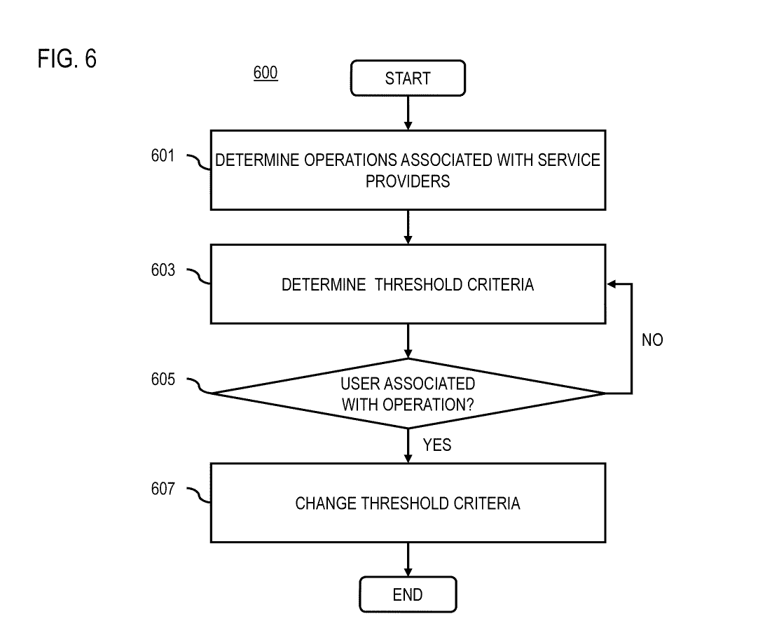

FIG. 6 is a flowchart of a process for revising threshold criteria, according to one embodiment. In one embodiment, the limit platform 113 performs the process 600 and is implemented in, for instance, a chip set including a processor and a memory as shown in FIG. 11. For step 601, the control logic 211 may determine one or more operations associated with one or more service providers. For example, the control logic 211 may determine operations wherein the one or more operations include one or more customer categorizations, sales promotions, policy changes, user groupings, receptacle classifications, or a combination thereof. Then, the control logic 211 may cause, at least in part, one or more changes to the threshold criteria based, at least in part, on the one or more operations. For example, for step 603, the control logic 211 may determine threshold criteria and then determine whether the operation pertains to the user in step 605. If the operation is relevant to a user, the control logic 211 may change the threshold criteria (step 607).

For example, an operation may include a user receiving a seating upgrade that also lets the user qualify for higher limits and therefore higher threshold criteria. In one embodiment, the control logic 211 may then determine an increase for the user from the standard limit and threshold criteria, to the higher threshold criteria. In one embodiment, the operation may also include a user participating in a group, which may allow grouping of the collective receptacles within the group. Then, the control logic 211 may adjust the threshold criteria from the standard threshold criteria of one user, to be the threshold criteria of the total members of the group. For example, if 20 kg is the standard limit for one user, a family of three may collectively share the threshold criteria of 60 kg (20 kg*3 people).

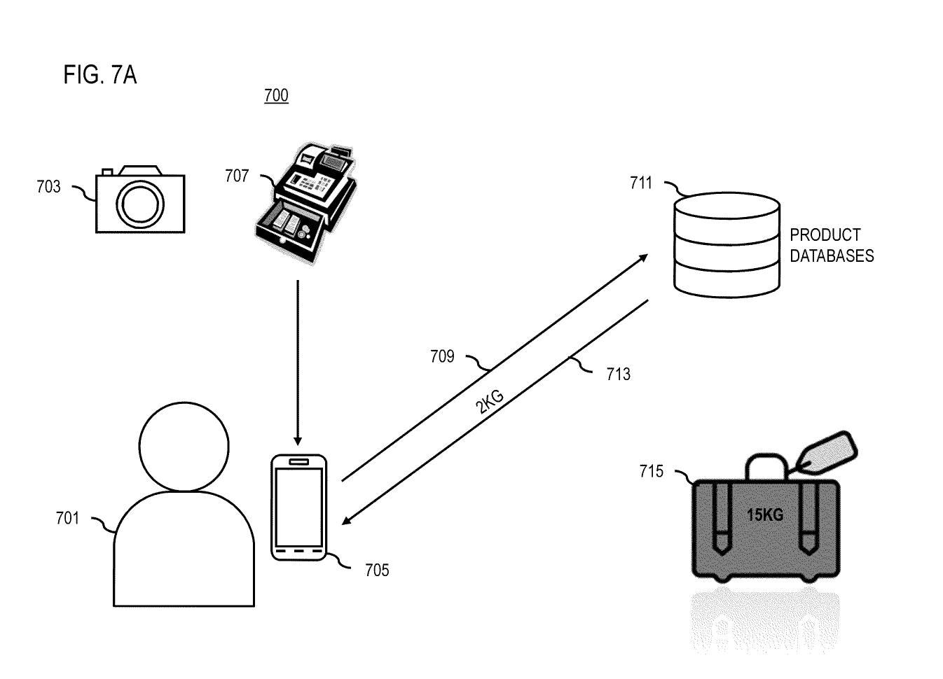

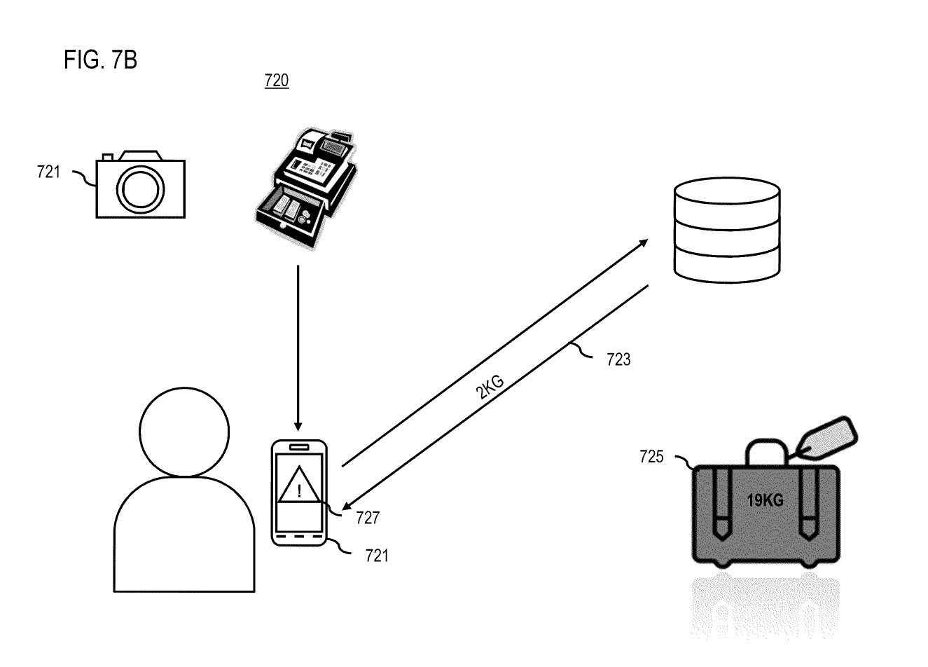

FIGS. 7A-7B are diagrams of a weight tracking system that executes the processes of FIG. 3, according to one embodiment. In one embodiment, scenario 700 shows where a user acquires items, prior to physical property values of the items exceeding one or more limits or threshold criteria. In one embodiment, a user 701 may acquire item 703. While paying, device 705 may determine a product identification code 707. For example, the user 701 may determine the product identification code 707 from a code rendered from a receipt or from a bar code scanning associated with item 703. Then, device 705 may send query 709 to product database 711 inquiring regarding the specifications and/or one or more physical property values. Then, product database 711 may send a reply 713 to device 705, where the reply 713 conveys a physical property value associated with the item 703. In one embodiment, the device 705 may organize the value to be associated with a receptacle categorization. Then, device 705 may add the physical property value in the reply, to a cumulative physical property value to calculate a new cumulative value. For example, device 705 may determine that item 703 be categorized such that it is associated with receptacle 715. With the physical property value returned by the product database 711 added, the device 705 may determine the cumulative physical property value of receptacle 715, to be 15 kg.

In one embodiment, scenario 720 shows where a user may exceed one or more limits or threshold criteria. In one embodiment, a device 721 may determine the physical property value 723 of an item to be 2 kg. Device 721 may also determine that a cumulative physical property value is 19 kg, or that a certain receptacle 725 has threshold criteria of only 1 kg remaining. If the device 721 organizes the item to be associated with the receptacle 725, the device 721 may determine that a 2 kg item exceeds the 1 kg threshold criteria. Where item acquisition would exceed the threshold criteria, device 721 may show display 727, warning the user that a limit is reached. In one embodiment, device 721 may show display 727 prior to the user acquiring an item so the user may then decide whether or not to acquire the item, given his constraints. In another embodiment, device 721 may offer one or more alternatives or options for the user to acquire the item, despite constraint. For instance, device 721 may show the nearby post offices for shipping, show the user promotions or sales options for purchasing upgrades to limits, show availability of the items, etc.

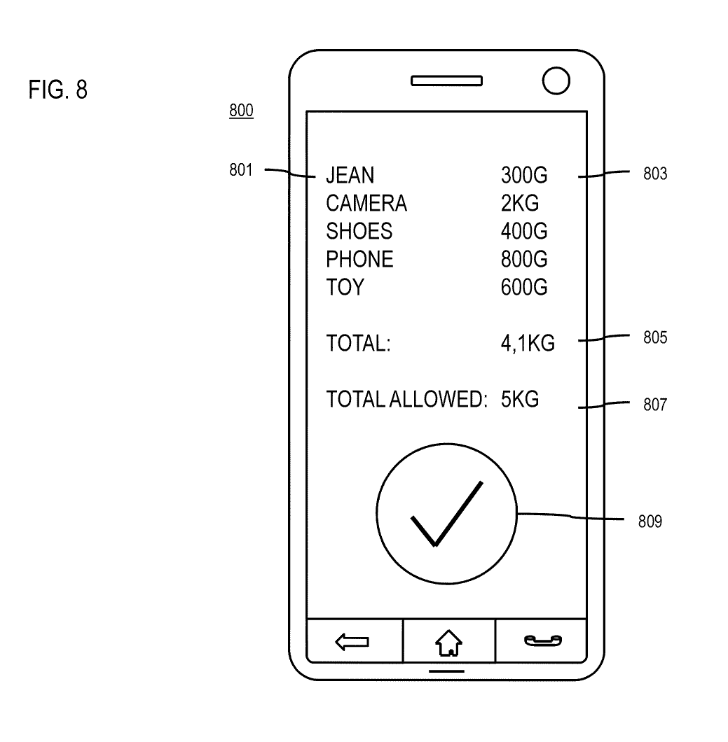

FIG. 8 is a diagram of a user interface utilized in the processes of FIG. 3, according to one embodiment. In one embodiment, the user interface may show items and their respective physical property values. For example, display 800 may include a list of items 801 and their respective weights 803. In one embodiment, the display 800 is an itemized listing of the items and their weights. In one embodiment, the display 800 may appear automatically after the system 100 determines acquisition of a new item, or upon user prompting. In a further embodiment, the display 800 may include the total weight 805 of all the items and a weight limit 807. In one embodiment, threshold criteria may be the difference between the total weight 805 of all the items and the weight limit 807. Furthermore, the display 800 may include a signal 809 as to whether the limit is exceeded. For example, signal 809 shows a check mark indicating that the limit 807 is not exceeded, perhaps indicating to a user that he may acquire more items. In one embodiment, a user may scroll between multiple displays for various receptacle categories, users, user groupings, physical properties, etc. For example, while display 800 pertains to item weights and weight limits for one user, multiple similar displays may be available for volume limits, size limits, multiple other users, selected versus acquired items, etc.

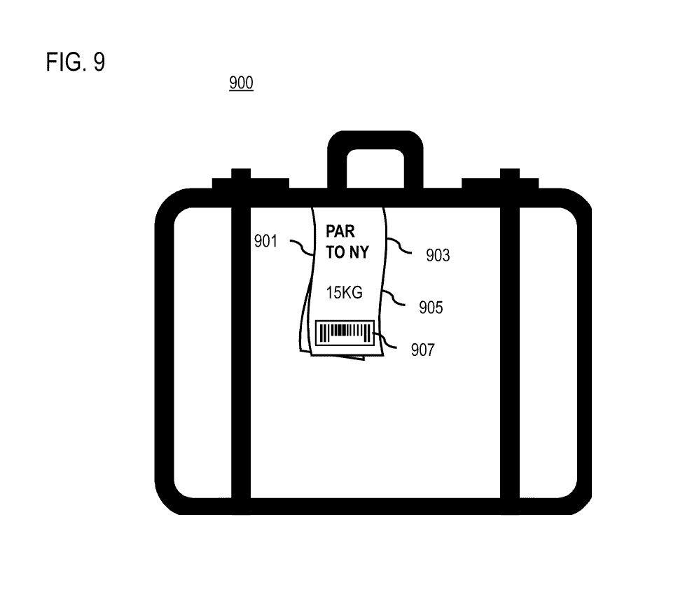

FIG. 9 is a diagram of a possible procedure utilized in the processes of FIG. 4, according to one embodiment. In one embodiment, luggage tags frequently show flight departure and arrival locations, along with a physical property value of the luggage. For example, as shown in scenario 900, the tag 901 contains flight details 903, luggage weight 905, and a bar code 907. The system 100 and/or user may user the luggage weight 905 to reference how many kilos worth of items may be purchased according to the flight details 903. In one embodiment, flight details 903 may also supplement the capability to provide recommendations. For example, the system 100 may recommend availability based on the flight details 903, in showing where a user may purchase an item depending on where he is flying. For example, the system 100 may determine that, rather than worry about fluid volume limitations when going through security, the user may purchase an item in an airport where he has a layover. In another example, the system 100 may determine from the flight details 903 that a flight is relatively short, so a user may purchase a perishable item prior to arriving at an airport, rather than acquiring it during his journey. In one embodiment, the user may scan the bar code 907 with his UE 101 for system 100 to determine initial values, threshold criteria, or a combination thereof

The processes described herein for organizing items into receptacle categories based, at least in part, on physical properties of the items may be advantageously implemented via software, hardware, firmware or a combination of software and/or firmware and/or hardware. For example, the processes described herein, may be advantageously implemented via processor(s), Digital Signal Processing (DSP) chip, an Application Specific Integrated Circuit (ASIC), Field Programmable Gate Arrays (FPGAs), etc. Such exemplary hardware for performing the described functions is detailed below.

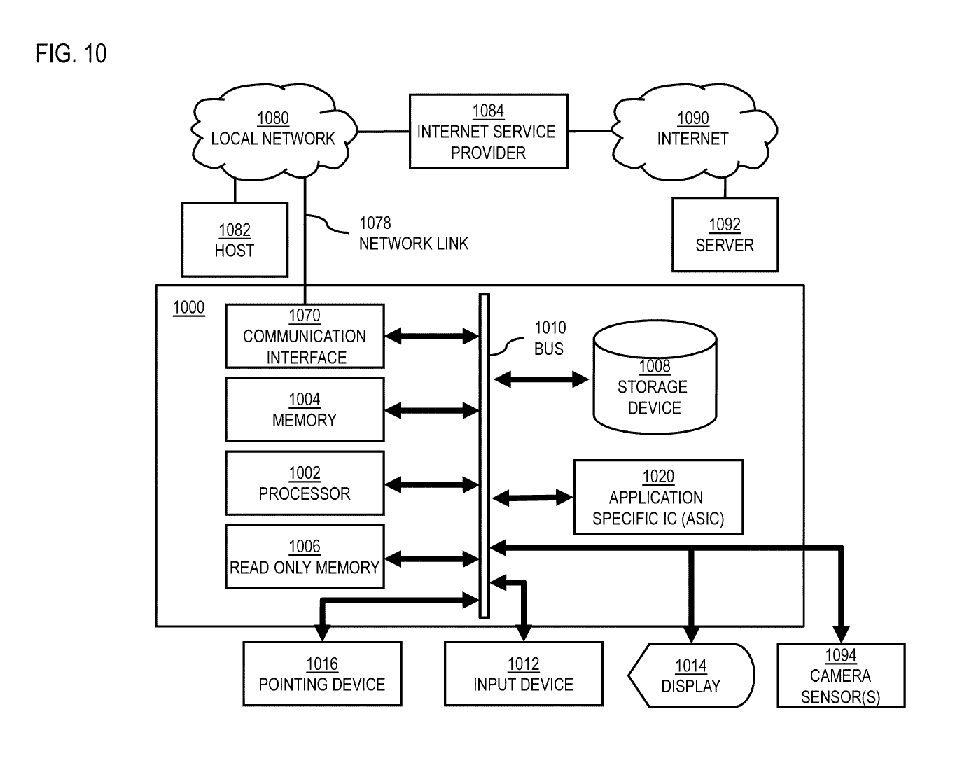

FIG. 10 illustrates a computer system 1000 upon which an embodiment of the invention may be implemented. Although computer system 1000 is depicted with respect to a particular device or equipment, it is contemplated that other devices or equipment (e.g., network elements, servers, etc.) within FIG. 10 can deploy the illustrated hardware and components of system 1000. Computer system 1000 is programmed (e.g., via computer program code or instructions) to organizing items into receptacle categories based, at least in part, on physical properties of the items as described herein and includes a communication mechanism such as a bus 1010 for passing information between other internal and external components of the computer system 1000. Information (also called data) is represented as a physical expression of a measurable phenomenon, typically electric voltages, but including, in other embodiments, such phenomena as magnetic, electromagnetic, pressure, chemical, biological, molecular, atomic, sub-atomic and quantum interactions. For example, north and south magnetic fields, or a zero and non-zero electric voltage, represent two states (0, 1) of a binary digit (bit). Other phenomena can represent digits of a higher base. A superposition of multiple simultaneous quantum states before measurement represents a quantum bit (qubit). A sequence of one or more digits constitutes digital data that is used to represent a number or code for a character. In some embodiments, information called analog data is represented by a near continuum of measurable values within a particular range. Computer system 1000, or a portion thereof, constitutes a means for performing one or more steps of organizing items into receptacle categories based, at least in part, on physical properties of the items.

A bus 1010 includes one or more parallel conductors of information so that information is transferred quickly among devices coupled to the bus 1010. One or more processors 1002 for processing information are coupled with the bus 1010.

A processor (or multiple processors) 1002 performs a set of operations on information as specified by computer program code related to organize items into receptacle categories based, at least in part, on physical properties of the items. The computer program code is a set of instructions or statements providing instructions for the operation of the processor and/or the computer system to perform specified functions. The code, for example, may be written in a computer programming language that is compiled into a native instruction set of the processor. The code may also be written directly using the native instruction set (e.g., machine language). The set of operations include bringing information in from the bus 1010 and placing information on the bus 1010. The set of operations also typically include comparing two or more units of information, shifting positions of units of information, and combining two or more units of information, such as by addition or multiplication or logical operations like OR, exclusive OR (XOR), and AND. Each operation of the set of operations that can be performed by the processor is represented to the processor by information called instructions, such as an operation code of one or more digits. A sequence of operations to be executed by the processor 1002, such as a sequence of operation codes, constitute processor instructions, also called computer system instructions or, simply, computer instructions. Processors may be implemented as mechanical, electrical, magnetic, optical, chemical or quantum components, among others, alone or in combination.

Computer system 1000 also includes a memory 1004 coupled to bus 1010. The memory 1004, such as a random access memory (RAM) or any other dynamic storage device, stores information including processor instructions for organizing items into receptacle categories based, at least in part, on physical properties of the items. Dynamic memory allows information stored therein to be changed by the computer system 1000. RAM allows a unit of information stored at a location called a memory address to be stored and retrieved independently of information at neighboring addresses. The memory 1004 is also used by the processor 1002 to store temporary values during execution of processor instructions. The computer system 1000 also includes a read only memory (ROM) 1006 or any other static storage device coupled to the bus 1010 for storing static information, including instructions, that is not changed by the computer system 1000. Some memory is composed of volatile storage that loses the information stored thereon when power is lost. Also coupled to bus 1010 is a non-volatile (persistent) storage device 1008, such as a magnetic disk, optical disk or flash card, for storing information, including instructions, that persists even when the computer system 1000 is turned off or otherwise loses power.

Information, including instructions for organizing items into receptacle categories based, at least in part, on physical properties of the items, is provided to the bus 1010 for use by the processor from an external input device 1012, such as a keyboard containing alphanumeric keys operated by a human user, or a sensor. A sensor detects conditions in its vicinity and transforms those detections into physical expression compatible with the measurable phenomenon used to represent information in computer system 1000. Other external devices coupled to bus 1010, used primarily for interacting with humans, include a display device 1014, such as a cathode ray tube (CRT), a liquid crystal display (LCD), a light emitting diode (LED) display, an organic LED (OLED) display, a plasma screen, or a printer for presenting text or images, and a pointing device 1016, such as a mouse, a trackball, cursor direction keys, or a motion sensor, for controlling a position of a small cursor image presented on the display 1014 and issuing commands associated with graphical elements presented on the display 1014. In some embodiments, for example, in embodiments in which the computer system 1000 performs all functions automatically without human input, one or more of external input device 1012, display device 1014 and pointing device 1016 is omitted.

In the illustrated embodiment, special purpose hardware, such as an application specific integrated circuit (ASIC) 1020, is coupled to bus 1010. The special purpose hardware is configured to perform operations not performed by processor 1002 quickly enough for special purposes. Examples of ASICs include graphics accelerator cards for generating images for display 1014, cryptographic boards for encrypting and decrypting messages sent over a network, speech recognition, and interfaces to special external devices, such as robotic arms and medical scanning equipment that repeatedly perform some complex sequence of operations that are more efficiently implemented in hardware.

Computer system 1000 also includes one or more instances of a communications interface 1070 coupled to bus 1010. Communication interface 1070 provides a one-way or two-way communication coupling to a variety of external devices that operate with their own processors, such as printers, scanners and external disks. In general the coupling is with a network link 1078 that is connected to a local network 1080 to which a variety of external devices with their own processors are connected. For example, communication interface 1070 may be a parallel port or a serial port or a universal serial bus (USB) port on a personal computer. In some embodiments, communications interface 1070 is an integrated services digital network (ISDN) card or a digital subscriber line (DSL) card or a telephone modem that provides an information communication connection to a corresponding type of telephone line. In some embodiments, a communication interface 1070 is a cable modem that converts signals on bus 1010 into signals for a communication connection over a coaxial cable or into optical signals for a communication connection over a fiber optic cable. As another example, communications interface 1070 may be a local area network (LAN) card to provide a data communication connection to a compatible LAN, such as Ethernet. Wireless links may also be implemented. For wireless links, the communications interface 1070 sends or receives or both sends and receives electrical, acoustic or electromagnetic signals, including infrared and optical signals, that carry information streams, such as digital data. For example, in wireless handheld devices, such as mobile telephones like cell phones, the communications interface 1070 includes a radio band electromagnetic transmitter and receiver called a radio transceiver. In certain embodiments, the communications interface 1070 enables connection to the communication network 105 for organizing items into receptacle categories based, at least in part, on physical properties of the items to the UE 101.

The term “computer-readable medium” as used herein refers to any medium that participates in providing information to processor 1002, including instructions for execution. Such a medium may take many forms, including, but not limited to computer-readable storage medium (e.g., non-volatile media, volatile media), and transmission media. Non-transitory media, such as non-volatile media, include, for example, optical or magnetic disks, such as storage device 1008. Volatile media include, for example, dynamic memory 1004. Transmission media include, for example, twisted pair cables, coaxial cables, copper wire, fiber optic cables, and carrier waves that travel through space without wires or cables, such as acoustic waves and electromagnetic waves, including radio, optical and infrared waves. Signals include man-made transient variations in amplitude, frequency, phase, polarization or other physical properties transmitted through the transmission media. Common forms of computer-readable media include, for example, a floppy disk, a flexible disk, hard disk, magnetic tape, any other magnetic medium, a CD-ROM, CDRW, DVD, any other optical medium, punch cards, paper tape, optical mark sheets, any other physical medium with patterns of holes or other optically recognizable indicia, a RAM, a PROM, an EPROM, a FLASH-EPROM, an EEPROM, a flash memory, any other memory chip or cartridge, a carrier wave, or any other medium from which a computer can read. The term computer-readable storage medium is used herein to refer to any computer-readable medium except transmission media.

Logic encoded in one or more tangible media includes one or both of processor instructions on a computer-readable storage media and special purpose hardware, such as ASIC 1020.

Network link 1078 typically provides information communication using transmission media through one or more networks to other devices that use or process the information. For example, network link 1078 may provide a connection through local network 1080 to a host computer 1082 or to equipment 1084 operated by an Internet Service Provider (ISP). ISP equipment 1084 in turn provides data communication services through the public, world-wide packet-switching communication network of networks now commonly referred to as the Internet 1090.

A computer called a server host 1092 connected to the Internet hosts a process that provides a service in response to information received over the Internet. For example, server host 1092 hosts a process that provides information representing video data for presentation at display 1014. It is contemplated that the components of system 1000 can be deployed in various configurations within other computer systems, e.g., host 1082 and server 1092.

At least some embodiments of the invention are related to the use of computer system 1000 for implementing some or all of the techniques described herein. According to one embodiment of the invention, those techniques are performed by computer system 1000 in response to processor 1002 executing one or more sequences of one or more processor instructions contained in memory 1004. Such instructions, also called computer instructions, software and program code, may be read into memory 1004 from another computer-readable medium such as storage device 1008 or network link 1078. Execution of the sequences of instructions contained in memory 1004 causes processor 1002 to perform one or more of the method steps described herein. In alternative embodiments, hardware, such as ASIC 1020, may be used in place of or in combination with software to implement the invention. Thus, embodiments of the invention are not limited to any specific combination of hardware and software, unless otherwise explicitly stated herein.

The signals transmitted over network link 1078 and other networks through communications interface 1070, carry information to and from computer system 1000. Computer system 1000 can send and receive information, including program code, through the networks 1080, 1090 among others, through network link 1078 and communications interface 1070. In an example using the Internet 1090, a server host 1092 transmits program code for a particular application, requested by a message sent from computer 1000, through Internet 1090, ISP equipment 1084, local network 1080 and communications interface 1070. The received code may be executed by processor 1002 as it is received, or may be stored in memory 1004 or in storage device 1008 or any other non-volatile storage for later execution, or both. In this manner, computer system 1000 may obtain application program code in the form of signals on a carrier wave.

Various forms of computer readable media may be involved in carrying one or more sequence of instructions or data or both to processor 1002 for execution. For example, instructions and data may initially be carried on a magnetic disk of a remote computer such as host 1082. The remote computer loads the instructions and data into its dynamic memory and sends the instructions and data over a telephone line using a modem. A modem local to the computer system 1000 receives the instructions and data on a telephone line and uses an infra-red transmitter to convert the instructions and data to a signal on an infra-red carrier wave serving as the network link 1078. An infrared detector serving as communications interface 1070 receives the instructions and data carried in the infrared signal and places information representing the instructions and data onto bus 1010. Bus 1010 carries the information to memory 1004 from which processor 1002 retrieves and executes the instructions using some of the data sent with the instructions. The instructions and data received in memory 1004 may optionally be stored on storage device 1008, either before or after execution by the processor 1002.

FIG. 11 illustrates a chip set or chip 1100 upon which an embodiment of the invention may be implemented. Chip set 1100 is programmed to organize items into receptacle categories based, at least in part, on physical properties of the items as described herein and includes, for instance, the processor and memory components described with respect to FIG. 10 incorporated in one or more physical packages (e.g., chips). By way of example, a physical package includes an arrangement of one or more materials, components, and/or wires on a structural assembly (e.g., a baseboard) to provide one or more characteristics such as physical strength, conservation of size, and/or limitation of electrical interaction. It is contemplated that in certain embodiments the chip set 1100 can be implemented in a single chip. It is further contemplated that in certain embodiments the chip set or chip 1100 can be implemented as a single “system on a chip.” It is further contemplated that in certain embodiments a separate ASIC would not be used, for example, and that all relevant functions as disclosed herein would be performed by a processor or processors. Chip set or chip 1100, or a portion thereof, constitutes a means for performing one or more steps of providing user interface navigation information associated with the availability of functions. Chip set or chip 1100, or a portion thereof, constitutes a means for performing one or more steps of organizing items into receptacle categories based, at least in part, on physical properties of the items.

In one embodiment, the chip set or chip 1100 includes a communication mechanism such as a bus 1101 for passing information among the components of the chip set 1100. A processor 1103 has connectivity to the bus 1101 to execute instructions and process information stored in, for example, a memory 1105. The processor 1103 may include one or more processing cores with each core configured to perform independently. A multi-core processor enables multiprocessing within a single physical package. Examples of a multi-core processor include two, four, eight, or greater numbers of processing cores. Alternatively or in addition, the processor 1103 may include one or more microprocessors configured in tandem via the bus 1101 to enable independent execution of instructions, pipelining, and multithreading. The processor 1103 may also be accompanied with one or more specialized components to perform certain processing functions and tasks such as one or more digital signal processors (DSP) 1107, or one or more application-specific integrated circuits (ASIC) 1109. A DSP 1107 typically is configured to process real-world signals (e.g., sound) in real time independently of the processor 1103. Similarly, an ASIC 1109 can be configured to performed specialized functions not easily performed by a more general purpose processor. Other specialized components to aid in performing the inventive functions described herein may include one or more field programmable gate arrays (FPGA) (not shown), one or more controllers (not shown), or one or more other special-purpose computer chips.

In one embodiment, the chip set or chip 1100 includes merely one or more processors and some software and/or firmware supporting and/or relating to and/or for the one or more processors.

The processor 1103 and accompanying components have connectivity to the memory 1105 via the bus 1101. The memory 1105 includes both dynamic memory (e.g., RAM, magnetic disk, writable optical disk, etc.) and static memory (e.g., ROM, CD-ROM, etc.) for storing executable instructions that when executed perform the inventive steps described herein to organize items into receptacle categories based, at least in part, on physical properties of the items. The memory 1105 also stores the data associated with or generated by the execution of the inventive steps.

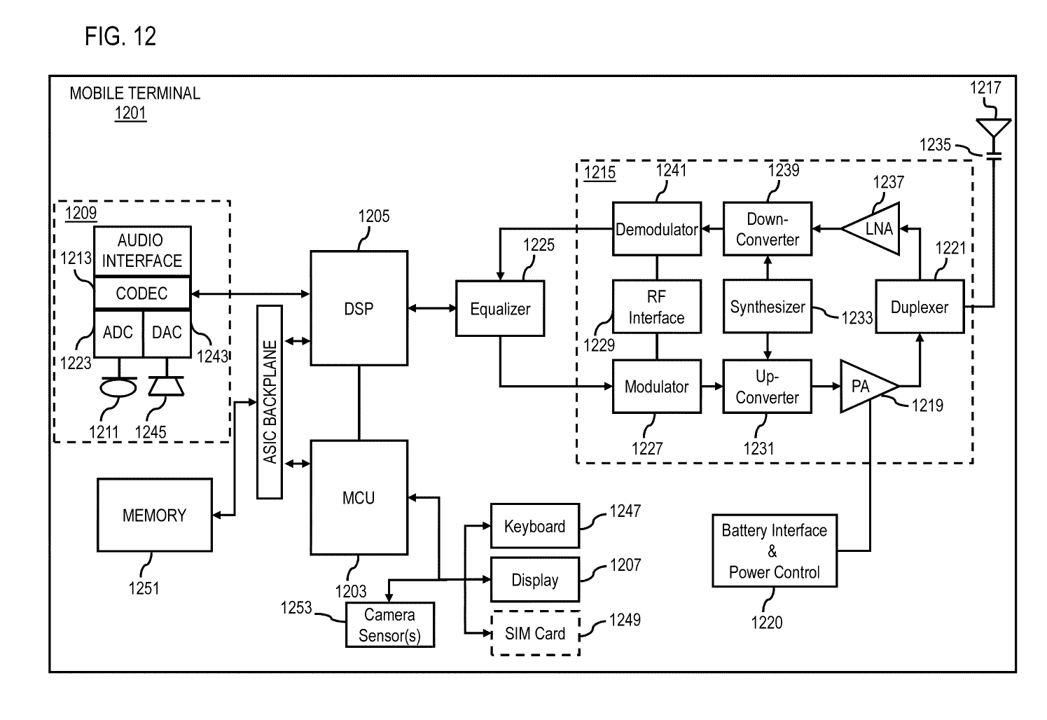

FIG. 12 is a diagram of exemplary components of a mobile terminal (e.g., handset) for communications, which is capable of operating in the system of FIG. 1, according to one embodiment. In some embodiments, mobile terminal 1201, or a portion thereof, constitutes a means for performing one or more steps of organizing items into receptacle categories based, at least in part, on physical properties of the items. Generally, a radio receiver is often defined in terms of front-end and back-end characteristics. The front-end of the receiver encompasses all of the Radio Frequency (RF) circuitry whereas the back-end encompasses all of the base-band processing circuitry. As used in this application, the term “circuitry” refers to both: (1) hardware-only implementations (such as implementations in only analog and/or digital circuitry), and (2) to combinations of circuitry and software (and/or firmware) (such as, if applicable to the particular context, to a combination of processor(s), including digital signal processor(s), software, and memory(ies) that work together to cause an apparatus, such as a mobile phone or server, to perform various functions). This definition of “circuitry” applies to all uses of this term in this application, including in any claims. As a further example, as used in this application and if applicable to the particular context, the term “circuitry” would also cover an implementation of merely a processor (or multiple processors) and its (or their) accompanying software/or firmware. The term “circuitry” would also cover if applicable to the particular context, for example, a baseband integrated circuit or applications processor integrated circuit in a mobile phone or a similar integrated circuit in a cellular network device or other network devices.

Pertinent internal components of the telephone include a Main Control Unit (MCU) 1203, a Digital Signal Processor (DSP) 1205, and a receiver/transmitter unit including a microphone gain control unit and a speaker gain control unit. A main display unit 1207 provides a display to the user in support of various applications and mobile terminal functions that perform or support the steps of organizing items into receptacle categories based, at least in part, on physical properties of the items. The display 1207 includes display circuitry configured to display at least a portion of a user interface of the mobile terminal (e.g., mobile telephone). Additionally, the display 1207 and display circuitry are configured to facilitate user control of at least some functions of the mobile terminal. An audio function circuitry 1209 includes a microphone 1211 and microphone amplifier that amplifies the speech signal output from the microphone 1211. The amplified speech signal output from the microphone 1211 is fed to a coder/decoder (CODEC) 1213.

A radio section 1215 amplifies power and converts frequency in order to communicate with a base station, which is included in a mobile communication system, via antenna 1217. The power amplifier (PA) 1219 and the transmitter/modulation circuitry are operationally responsive to the MCU 1203, with an output from the PA 1219 coupled to the duplexer 1221 or circulator or antenna switch, as known in the art. The PA 1219 also couples to a battery interface and power control unit 1220.

In use, a user of mobile terminal 1201 speaks into the microphone 1211 and his or her voice along with any detected background noise is converted into an analog voltage. The analog voltage is then converted into a digital signal through the Analog to Digital Converter (ADC) 1223. The control unit 1203 routes the digital signal into the DSP 1205 for processing therein, such as speech encoding, channel encoding, encrypting, and interleaving. In one embodiment, the processed voice signals are encoded, by units not separately shown, using a cellular transmission protocol such as enhanced data rates for global evolution (EDGE), general packet radio service (GPRS), global system for mobile communications (GSM), Internet protocol multimedia subsystem (IMS), universal mobile telecommunications system (UMTS), etc., as well as any other suitable wireless medium, e.g., microwave access (WiMAX), Long Term Evolution (LTE) networks, code division multiple access (CDMA), wideband code division multiple access (WCDMA), wireless fidelity (WiFi), satellite, and the like, or any combination thereof.

The encoded signals are then routed to an equalizer 1225 for compensation of any frequency-dependent impairments that occur during transmission though the air such as phase and amplitude distortion. After equalizing the bit stream, the modulator 1227 combines the signal with a RF signal generated in the RF interface 1229. The modulator 1227 generates a sine wave by way of frequency or phase modulation. In order to prepare the signal for transmission, an up-converter 1231 combines the sine wave output from the modulator 1227 with another sine wave generated by a synthesizer 1233 to achieve the desired frequency of transmission. The signal is then sent through a PA 1219 to increase the signal to an appropriate power level. In practical systems, the PA 1219 acts as a variable gain amplifier whose gain is controlled by the DSP 1205 from information received from a network base station. The signal is then filtered within the duplexer 1221 and optionally sent to an antenna coupler 1235 to match impedances to provide maximum power transfer. Finally, the signal is transmitted via antenna 1217 to a local base station. An automatic gain control (AGC) can be supplied to control the gain of the final stages of the receiver. The signals may be forwarded from there to a remote telephone which may be another cellular telephone, any other mobile phone or a land-line connected to a Public Switched Telephone Network (PSTN), or other telephony networks.

Voice signals transmitted to the mobile terminal 1201 are received via antenna 1217 and immediately amplified by a low noise amplifier (LNA) 1237. A down-converter 1239 lowers the carrier frequency while the demodulator 1241 strips away the RF leaving only a digital bit stream. The signal then goes through the equalizer 1225 and is processed by the DSP 1205. A Digital to Analog Converter (DAC) 1243 converts the signal and the resulting output is transmitted to the user through the speaker 1245, all under control of a Main Control Unit (MCU) 1203 which can be implemented as a Central Processing Unit (CPU) (not shown).

The MCU 1203 receives various signals including input signals from the keyboard 1247. The keyboard 1247 and/or the MCU 1203 in combination with other user input components (e.g., the microphone 1211) comprise a user interface circuitry for managing user input. The MCU 1203 runs a user interface software to facilitate user control of at least some functions of the mobile terminal 1201 to organizing items into receptacle categories based, at least in part, on physical properties of the items. The MCU 1203 also delivers a display command and a switch command to the display 1207 and to the speech output switching controller, respectively. Further, the MCU 1203 exchanges information with the DSP 1205 and can access an optionally incorporated SIM card 1249 and a memory 1251. In addition, the MCU 1203 executes various control functions required of the terminal. The DSP 1205 may, depending upon the implementation, perform any of a variety of conventional digital processing functions on the voice signals. Additionally, DSP 1205 determines the background noise level of the local environment from the signals detected by microphone 1211 and sets the gain of microphone 1211 to a level selected to compensate for the natural tendency of the user of the mobile terminal 1201.

The CODEC 1213 includes the ADC 1223 and DAC 1243. The memory 1251 stores various data including call incoming tone data and is capable of storing other data including music data received via, e.g., the global Internet. The software module could reside in RAM memory, flash memory, registers, or any other form of writable storage medium known in the art. The memory device 1251 may be, but not limited to, a single memory, CD, DVD, ROM, RAM, EEPROM, optical storage, magnetic disk storage, flash memory storage, or any other non-volatile storage medium capable of storing digital data.

An optionally incorporated SIM card 1249 carries, for instance, important information, such as the cellular phone number, the carrier supplying service, subscription details, and security information. The SIM card 1249 serves primarily to identify the mobile terminal 1201 on a radio network. The card 1249 also contains a memory for storing a personal telephone number registry, text messages, and user specific mobile terminal settings.

While the invention has been described in connection with a number of embodiments and implementations, the invention is not so limited but covers various obvious modifications and equivalent arrangements, which fall within the purview of the appended claims. Although features of the invention are expressed in certain combinations among the claims, it is contemplated that these features can be arranged in any combination and order.

What is claimed is:

1. A method comprising facilitating a processing of and/or processing (1) data and/or (2) information and/or (3) at least one signal, the (1) data and/or (2) information and/or (3) at least one signal based, at least in part, on the following:
an acquisition of at least one item by at least one user;
a querying for at least one physical property value for the at least one item; and
at least one determination of an organization of the at least one item into one or more receptacle categories based, at least in part, on the physical property value.

2. A method of claim 1, wherein the at least one physical property value includes, at least in part, a weight value, a physical dimension value, physical state, or a combination thereof.

3. A method of claim 1, wherein the (1) data and/or (2) information and/or (3) at least one signal are further based, at least in part, on the following:
an addition of the at least one physical property value to at least one cumulative physical property value associated with that at least one user; and
a comparison of the at least one cumulative physical property value, an initial weight value, or a combination thereof, against one or more threshold criteria.

4. A method of claim 3, wherein the one or more threshold criteria is based, at least in part, on at least one weight limit, at least one size limit, at least one volume limit, or a combination thereof of a receptacle.

5. A method of claim 4, wherein the (1) data and/or (2) information and/or (3) at least one signal are further based, at least in part, on the following:
at least one determination of the one or more threshold criteria based, at least in part, on a difference between (a) the at least one weight limit, the at least one size limit, the at least one volume limit, or a combination thereof, and (b) the weight value, the initial weight value, an initial size value, an initial volume value, or a combination thereof for the receptacle.

6. A method of claim 1, wherein the (1) data and/or (2) information and/or (3) at least one signal are further based, at least in part, on the following:
a selection of at least one other item; and
a querying for at least one physical property for the at least one selected item; and
a grouping of the at least one selected item distinct from the at least one acquired item.

7. A method of claim 6, wherein the (1) data and/or (2) information and/or (3) at least one signal are further based, at least in part, on the following:
at least one determination of an availability of the at least one selected item at one or more locations; and
a display showing the availability of the at least one selected item at the one or more locations.

8. A method of claim 7, wherein the (1) data and/or (2) information and/or (3) at least one signal are further based, at least in part, on the following:
a request to reserve the at least one selected item at the one or more locations.

9. A method of claim 3, wherein the (1) data and/or (2) information and/or (3) at least one signal are further based, at least in part, on the following:
at least one determination of one or more operations associated with one or more service providers; and
one or more changes to the threshold criteria based, at least in part, on the one or more operations.

10. A method of claim 9, wherein the one or more operations include, at least in part, one or more customer categorizations, sales promotions, policy changes, user groupings, receptacle classifications, or a combination thereof.

11. An apparatus comprising:
at least one processor; and
at least one memory including computer program code for one or more programs,
the at least one memory and the computer program code configured to, with the at least one processor, cause the apparatus to perform at least the following,
determine an acquisition of at least one item by at least one user;
cause, at least in part, a querying for at least one physical property value for the at least one item; and
determine an organization of the at least one item into one or more receptacle categories based, at least in part, on the physical property value.

12. An apparatus of claim 11, wherein the at least one physical property value includes, at least in part, a weight value, a physical dimension value, physical state, or a combination thereof.

13. An apparatus of claim 11, wherein the apparatus is further caused to:
cause, at least in part, an addition of the at least one physical property value to at least one cumulative physical property value associated with that at least one user; and
cause, at least in part, a comparison of the at least one cumulative physical property value, an initial weight value, or a combination thereof, against one or more threshold criteria.

14. An apparatus of claim 13, wherein the one or more threshold criteria is based, at least in part, on at least one weight limit, at least one size limit, at least one volume limit, or a combination thereof of a receptacle.

15. An apparatus of claim 14, wherein the apparatus is further caused to:
determine the one or more threshold criteria based, at least in part, on a difference between (a) the at least one weight limit, the at least one size limit, the at least one volume limit, or a combination thereof, and (b) the weight value, the initial weight value, an initial size value, an initial volume value, or a combination thereof for the receptacle.

16. An apparatus of claim 11, wherein the apparatus is further caused to:
determine a selection of at least one other item; and
cause, at least in part, a querying for at least one physical property for the at least one selected item; and
cause, at least in part, a grouping of the at least one selected item distinct from the at least one acquired item.

17. An apparatus of claim 16, wherein the apparatus is further caused to:
determine an availability of the at least one selected item at one or more locations; and
cause, at least in part, a display showing the availability of the at least one selected item at the one or more locations.

18. An apparatus of claim 17, wherein the apparatus is further caused to:
determine a request to reserve the at least one selected item at the one or more locations.

19. An apparatus of claim 13, wherein the apparatus is further caused to:
determine one or more operations associated with one or more service providers; and
cause, at least in part, one or more changes to the threshold criteria based, at least in part, on the one or more operations.

20. An apparatus of claim 19, wherein the one or more operations include, at least in part, one or more customer categorizations, sales promotions, policy changes, user groupings, receptacle classifications, or a combination thereof.

21.-48. (canceled)
